(19) United States
(12) Patent Application Publication
(10) Pub. No.: US 2019/0125022 A1
(43) Pub. Date: May 2, 2019

(54) METHOD AND SYSTEM FOR ON DEMAND PRODUCTION OF APPARELS

(71) Applicant: PerfectFit Systems Pvt. Ltd., Cochin (IN)

(72) Inventor: Eobin Alex GEORGE, Cochin (IN)

(21) Appl. No.: 16/056,188

(22) Filed: Aug. 6, 2018

(30) Foreign Application Priority Data
Oct. 27, 2017 (IN) 201741038148

(51) Int. Cl. A41H 3/00; A41H 3/04; A41H 42/00; B26D 5/00; G06F 17/50; G06Q 30/06

(52) U.S. Cl. CPC A41H 3/007; A41H 3/04; A41H 42/00; G06F 2217/32; G06F 17/50; G06Q 30/0621; B26D 5/005

(57) ABSTRACT

A system for a rapid production of apparel executes instructions to cause one or more processors to perform an on-demand production method. The method includes a first step of receiving a first set of data associated with the body shape of the user and a second step of selecting the one or more apparel. A third step is collecting a second set of data including one or more user preferences, and a fourth step is analyzing the first set of data and the second set of data. A fifth step is cutting the material, and a sixth step is stitching the one or more material pieces together. A seventh step is finishing the apparel, and an eighth step is tracking the status of the apparel.

### TECHNICAL FIELD

The present disclosure relates to a field of apparel production. More specifically, the present disclosure relates to a system for a rapid production of on demand apparel.

### BACKGROUND

With the development of sophisticated computer vision techniques for solving trivial problems in the recent years, demand for systems that reduce the unnecessary stock of clothing in the store has increased. The merchant running the store purchases clothes in bulk from multiple places. Merchants in general have little idea of selling their maximum inventory due to changes in fashion trends in clothing industry. In most cases, merchants are not able to get the clothes which satisfy customer needs. Instead of having a large of collection of clothes, they are unable to fulfil the demands of their customer. Further, the merchant faces size related issues. To add to the issue, the present techniques don't provide any efficient solutions for fulfilling the customer need for apparel and therefore, poses a challenge for merchants.

### SUMMARY

In a first example, a computer-implemented on-demand production method is provided. The computer-implemented method is configured for a rapid production of apparel based on processing of a plurality of depth maps of a body of a user. The computer-implemented method may include a first step of receiving a first set of data associated with the body shape and size of the user. In addition, the computer-implemented method may include a second step of selecting the one or more apparel to be produced from the one or more available sources. Further, the computer-implemented method may include a third step of collecting a second set of data including one or more preferences of the user. Furthermore, the computer-implemented method may include a fourth step of analyzing the first set of data and the second set of data to get the one or more parameters required for the production of the selected one or more apparel. Also, the computer-implemented method may include a fifth step of cutting the material of the apparel preferred by the user into one or more apparel pieces based on the analyzing of the first set of data and the second set of data. The computer-implemented method may include a sixth step of stitching the one or more apparel pieces together to produce the apparel selected by the user. The computer-implemented method may include a seventh step of finishing the apparel selected by the user by performing one or more operations. The computer-implemented method may include an eighth step of tracking a current status of the apparel produced by the plurality of apparel manufacturing machines. The first set of data is received from the one or more scanners or one or more web based platforms to extract sizing parameters of the body of the user. In addition, the one or more available sources include the online sources and the offline sources. The one or more preferences of the user are used for the production of the selected apparel based on the preferences given by the user. The analyzing is done in real time. The cutting of the material preferred by the user is done by a plurality of apparel manufacturing machines. The stitching of the one or more apparel pieces is done based on the analyzing of first set of data and the second set of data. In addition, the stitching is done by the plurality of apparel manufacturing machines. The one or more operations include ironing, removing unwanted material, packaging and incorporating one or more hardware. The finishing is done by the plurality of apparel manufacturing machines. The tracking of the current status of the apparel is done in real time.

In an embodiment of the present disclosure, the first set of data includes a plurality of depth maps of the body of the user. In addition, the first set of data characterizes a three-dimensional geometry of the body of the user from a plurality of spatial parameters, a posture of the body, a position of each feature of a plurality of features of the body. Further, the first set of data characterizes an axis of reference and a position of joints, two dimensional image of the body of the user, three dimensional image of the body of the user. Furthermore, the first set of data characterizes scan data of the body of the user and size of each feature of the plurality of features.

In an embodiment of the present disclosure, the second set of data includes one or more fit preferences, type of fabrics, type of notions, design preferences, brands preferences, and monetary/cost preferences. In addition, the second set of data includes shape preference, color of fabric, choice of customized finishing, thread selection and choice of hardware.

In an embodiment of the present disclosure, the plurality of apparel manufacturing machines includes cutting machines, printing machines, embroidery machines, coloring machines. In addition, the plurality of apparel manufacturing machines includes stitching machine, joining machine, folding machine and finishing machines. The plurality of apparel manufacturing machines is used for the manufacturing of apparel in high quantity within in a short interval of time to fulfill demands of customers.

In an embodiment of the present disclosure, the one or more preferences of the user are recommended automatically by using machine learning algorithms. In addition, the machine learning algorithms is based on past data and real time data of the user associated with the one or more web based platform and social platforms.

In an embodiment of the present disclosure, the plurality of apparel manufacturing machines is partially automated.

In an embodiment of the present disclosure, the plurality of apparel manufacturing machines is fully automated.

In an embodiment of the present disclosure, the first set of data is further received from one or more images uploaded by the user on one or more sources. The one or more sources include social platforms and the web based platforms. The first set of data received from the one or more images is used to estimate body size parameters, determine choices of the user in color, fabrics, design and fit sizes for the production and recommendation of apparel.

In an embodiment of the present disclosure, the computer-implemented method includes another step of customizing design of the apparel based on the second set of data. The customization of apparel is done in real time.

In a second example, a computer system is provided. The computer system includes one or more processors and a memory coupled to the one or more processors. The memory stores instructions which, when executed by the one or more processors cause the one or more processors to perform a method. The method is used for a rapid production of apparel based on the processing of a plurality of depth maps of a body of a user. The method includes a first step of receiving a first set of data associated with the body shape and size of the user. In addition, the method includes a second step of selecting the one or more apparel to be produced from the one or more available sources. Further, the method includes a third step of collecting a second set of data including one or more preferences of the user. Furthermore, the method includes a fourth step of analyzing the first set of data and the second set of data to get the one or more parameters required for the production of the selected one or more apparel. Also, the method includes a fifth step of cutting the material of the apparel preferred by the user into one or more apparel pieces based on the analyzing of the first set of data and the second set of data. The method includes a sixth step of stitching the one or more apparel pieces together to produce the apparel selected by the user. The method includes a seventh step of finishing the apparel selected by the user by performing one or more operations. The method includes an eighth step of tracking a current status of the apparel produced by the plurality of apparel manufacturing machines. The first set of data is received from the one or more scanners or one or more web based platforms to extract sizing parameters of the body of the user. In addition, the one or more available sources include the online sources and the offline sources. Further, the selection of the one or more apparel is done by the user in real time. The one or more preferences of the user are used for the production of the selected apparel based on the preferences given by the user. The analyzing is done in real time. The cutting of the material preferred by the user is done by a plurality of apparel manufacturing machines. The stitching of the one or more apparel pieces is done based on the analyzing of the first set of data and the second set of data. In addition, the stitching is done by the plurality of apparel manufacturing machines. The one or more operations include ironing, removing unwanted material, packaging and incorporating one or more hardware. The finishing is done by the plurality of apparel manufacturing machines. The tracking of the current status of the apparel is done in real time.

In a third example, a computer-readable storage medium is provided. The computer-readable storage medium encodes computer executable instructions that, when executed by at least one processor, performs a method. The method is configured for a rapid production of apparel based on processing of a plurality of depth maps of a body of a user. The method may include a first step of receiving a first set of data associated with the body shape of the user. In addition, the method may include a second step of selecting the one or more apparel to be produced from the one or more available sources. Further, the method may include a third step of collecting a second set of data including one or more preferences of the user. Furthermore, the method may include a fourth step of analyzing the first set of data and the second set of data to get the one or more parameters required for the production of the selected one or more apparel. Also, the method may include a fifth step of cutting the material of the apparel preferred by the user into one or more apparel pieces based on the analyzing of the first set of data and the second set of data. The method may include a sixth step of stitching the one or more apparel pieces together to produce the apparel selected by the user. The method may include a seventh step of finishing the apparel selected by the user by performing one or more operations. The method may include an eighth step of tracking a current status of the apparel produced by the plurality of apparel manufacturing machines. The first set of data is received from the one or more scanners or one or more web based platforms to extract sizing parameters of the body of the user. In addition, the one or more available sources include the online sources and the offline sources. Further, the selection of the one or more apparel is done by the user in real time. The one or more preferences of the user are used for the production of the selected apparel based on the preferences given by the user. The analyzing is done in real time. The cutting of the material preferred by the user is done by a plurality of apparel manufacturing machines. The stitching of the one or more apparel pieces is done based on the analyzing of the first set of data and the second set of data. In addition, the stitching is done by the plurality of apparel manufacturing machines. The one or more operations include ironing, removing unwanted material, packaging and incorporating one or more hardware. The finishing is done by the plurality of apparel manufacturing machines. The tracking of the current status of the apparel is done in real time.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment to scan body of a user for collecting various sizing parameters, in accordance with an embodiment of the present disclosure;

FIG. 2 illustrates an interactive computing environment for production of on demand apparel based on the scan sized parameters, in accordance with an embodiment of the present disclosure;

FIG. 3A and FIG. 3B illustrates a flowchart for a method for rapid production of on demand apparel based on processing of a plurality of depth maps of body of a user, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

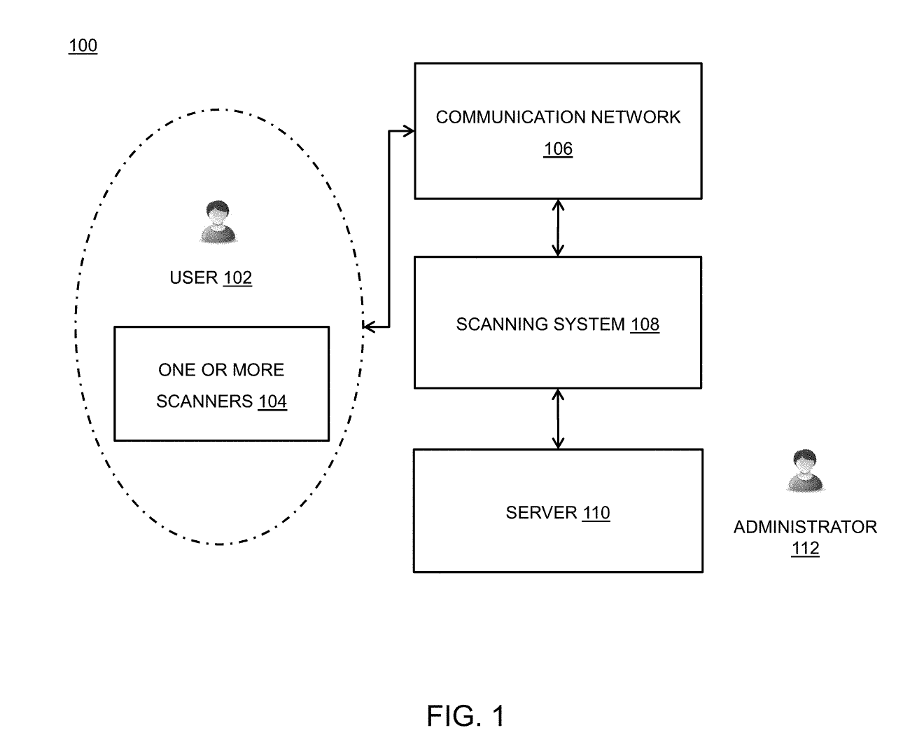

FIG. 1 illustrates a block diagram 100 of an interactive computing environment to scan body of a user for collecting body sized parameters, in accordance with an embodiment of the present disclosure. The interactive computing environment includes one or more scanners 104, a communication network 106, a scanning system 108 and a server 110.

The one or more scanners 104 are used for performing body scans of the user 102. In addition, the one or more scanners 104 are used to get three dimensional (hereinafter “3D”) scans of body of the user. The one or more scanners 104 may be present in any environment to collect different body scans of the user 102. In an example, the environment includes but may not be limited to a retail store, any factory, any gym and any virtual trial room. In an embodiment of the present disclosure, any physical retail store includes the one or more scanners 104 to know the various size parameters of the body of the user 102. In addition, the one or more scanners 114 are used to cover most of the body points from the body of the user 102 for the accurate measurements.

In an embodiment of the present disclosure, the one or more scanners 104 may be a motion sensing input devices for capturing detailed and accurate depth images of the body of the user 102. In an example, the one or more scanners include a laser ranging system, one or more depth cameras, RGB/spectral cameras, weighing scale, rotary devices and the like. The one or more scanners 104 scan the body of the user 102 with different angles and position. Each scanner of the one or more scanners 104 may use background software or applications to process the mathematical and statistical data models of the user 102. Examples of the one or more scanners 104 include but may not be limited to intel Realsense, asus Xtion and Microsoft Kinect. The one or more scanners 104 scan the body of the user 102 to get 3D and 2D image of the user 102. In an embodiment of the present disclosure, the one or more scanners 104 may be fixed scanners. In another embodiment of the present disclosure, the one or more scanners 104 may be movable scanners. In yet another embodiment of the present disclosure, the one or more scanners 104 may be rotated on an axis to scan the body of the user 102 from one or more different orientation. In yet another embodiment of the present disclosure, the one or more scanners 104 may move according to the position of the user 102.

In an embodiment of the present disclosure, the one or more scanners 104 may be associated with an interactive kiosk. The interactive kiosk may include a display panel, input devices, power ports and network ports for the bridging and serving data between the scanning system 108, the one or more scanners 104. The interactive kiosk uses gesture navigation for on-screen navigation and display of virtual mirror. In general, the interactive kiosk is a facility for performing body scans and displaying results. The results may be in the form of information about the various sized parameters of the body of the user 102. Moreover, the one or more scanners 104 are installed with the kiosk.

In an embodiment of the present disclosure, the one or more scanners 104 include a multi-camera mobile device for performing body scan of the user 102. The multi-camera mobile device includes a first camera and a second camera. The first camera and the second camera are placed on the same face of the multi-camera mobile devices to capture a 2D image of the body of the user 102. The first camera and the second camera capture images of the body of the user 102 simultaneously. The 2D images may be processed in the mobile device or may be uploaded on cloud infrastructure for depth, posture and feature estimation. Examples of the multi-camera mobile device include but may not be limited to a smartphone, digital pocket camera and digital reflex single lens camera.

In another embodiment of the present disclosure, the one or more scanners 104 include a single camera mobile device for capturing 2D images of the body of the user 102. The single-camera mobile device includes a single camera on any face of the mobile device. The single camera mobile device captures two shots of 2D images of the body of the user 102 in a short duration of time. The two shots are captured with different focus and zoom. Each pair of two shots of 2D images may be processed in the mobile device or may be uploaded on cloud infrastructure for depth, posture and feature estimation. Examples of the single-camera mobile device include but may not be limited to the smartphones, pocket camera, hand cam and DSLR.

In yet another embodiment of the present disclosure, the one or more scanners 104 may be linked with an online portal. The scanned data of the body of the user 102 from the one or more scanners 104 may be uploaded via the online portal. The online portal may correspond to any e-solution or e-services website for processing the scanned data of the body of the user 102. The online portal may be accessed from any communication device. The communication device includes but may not be limited to personal computer, laptops, smartphones and tablets.

In an example, the scanned data of the body of the user 102 is uploaded on the e-shopping platform. The e-shopping platform recommends one or more apparel to the user 102 based on the scan data of the body of the user 102. In another example, the e-shopping platform may allow the user 102 to order one or more apparel of the choice of the user. The e-shopping platform may provide on demand production and delivery of the one or more apparel in real time based on the order and preferences of the user 102.

In an example, the one or more scanners 104 are installed for taking the body measurements at various places such as uniform suppliers, sports apparel providers, wedding wear providers, off sizes apparel shops. In addition, the various places include custom apparel shops, readymade apparel size recommendation places, shops related to the production of shoes, caps, custom accessories providers. Further, the various places include physical rehab, sports rehab, fitness training centers and sports training centers.

The scan data of the body of the user 102 is uploaded to the scanning system 108 through the communication network 106. In general, the communication network 106 is a part of a network layer responsible for connection of two or more communication devices. The communication network 106 may be any type of network. Examples of the communication network 106 include but may not be limited to a wireless mobile network, a wired network, a combination of wireless and wired network and an optical fiber high bandwidth network. Moreover, the communication network 106 provides a medium for transfer of scan data from the one or more scanners 104 to the scanning system 108.

The interactive computing environment includes the scanning system 108. In an embodiment of the present disclosure, the scanning system 108 is a cloud server for remote computation and processing. In another embodiment of the present disclosure, the scanning system 108 is a SoC (system on chip) embedded system installed in the computing devices. The scanning system 108 is used to process the scan data of the user 102 for different operations. In an example, the operation includes but may not be limited to 3D body mapping, displaying body metrics, facilitates virtual trial room, preparing size chart for the body of the user 102. The scanning system 108 performs statistical and probabilistic computation on image and the scan data of the user 102. The scanning system 108 receives the set of data which includes the plurality of depth maps of the body of the user 102. The set of data is analyzed to infer the plurality of spatial parameters of the body of the user 102. The plurality of spatial parameters includes but may not be limited to a posture of the body, a position of each feature of a plurality of features of the body. In addition the plurality of spatial parameters includes an axis of reference, a position of joints and a height of the body of the user 102. Each feature corresponds to an identifiable portion of a human body. Examples of feature include but may not be limited to head, neck, leg, arm, shoulder, chest, waist, biceps, butts and torso. The depth data from 3D and 2D images can be used to estimate body metrics. The depth data includes but may not be limited to 3D data, 2D data, reconstructed 3D data, pseudo 3D data and direct depth data.

Furthermore, the scanning system 108 estimates the position of each feature of the plurality of features of the body of the user 102. In an embodiment of the present disclosure, the position of each feature of the plurality of features of the body of the user 102 is estimated based on a machine learning model. In another embodiment of the present disclosure, the position of each feature of the plurality of features of the body of the user 102 is estimated by other suitable method. The scanning system 108 slices each feature of the plurality of features to measures a set of feature metrics of each sliced feature of the plurality of features. The set of feature metrics are associated with spatial geometric measurements of the body of the user 102. Moreover, the set of feature metrics include but may not be limited to a body height, a leg length, an arm length, a shoulder width, a chest radius, a waist radius, a buttocks radius. In addition, the set of features metrics include an arm radius, a leg radius, a torso length and a shoulder length.

The scanning system 108 creates one or more feature metric databases for each sliced feature of the plurality of features. The scanning system 108 stores the one or more feature metric databases in the one or more user databases. Each feature metric database of the one or more feature metric databases corresponds to a measured set of feature metrics. Each feature metric database of the one or more feature metric databases includes a normalized size and a range of sizes for each feature of the body of the user 102.

The scanning system 108 is further associated with the server 110. The server 110 includes the database of various sized parameters of the user 102. In an example, the server may be a product designer, a product manufacturer, a product distributor and a retailer. The server 110 shares data from the database against requests from the scanning system 108.

In an embodiment of the present disclosure, the server 110 handles each operation and task performed by the scanning system 108. The server 110 is associated with one or more administrator. The administrator 112 may be any person or individual. In an example, the administrator 112 may be a product designer, a product manufacturer, a product distributor and a retailer.

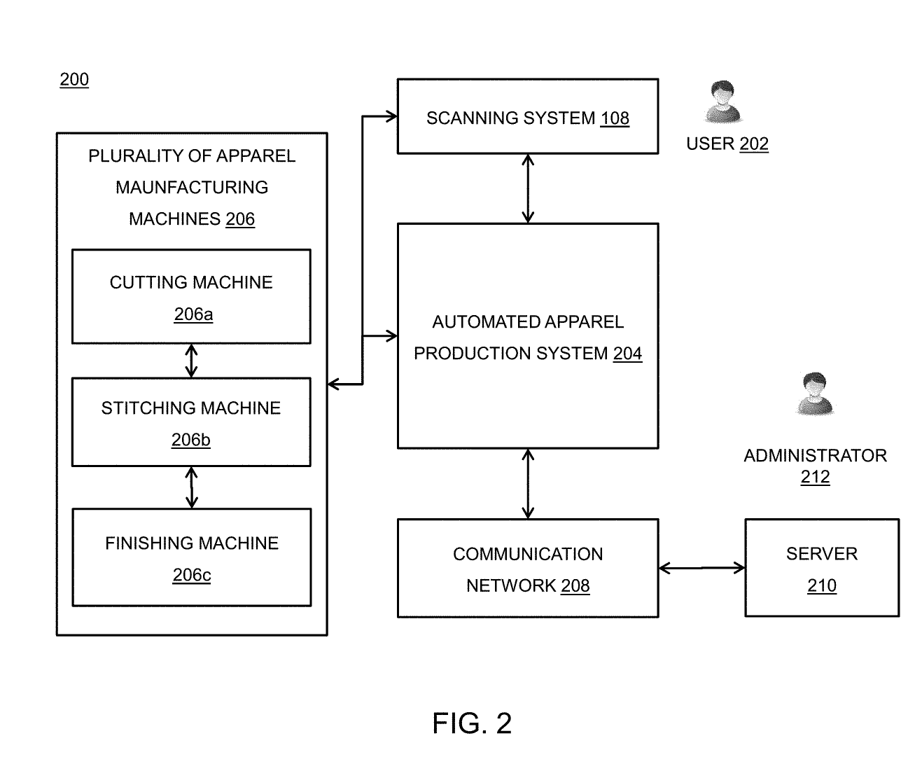

FIG. 2 illustrates an interactive computing environment for on demand production of the apparel based on the scan data. The interactive computing environment include a user 202, a scanning system 108, an automated apparel production system 204, a plurality of apparel manufacturing machines 206, a communication network 208 and a server 210.

In an embodiment of the present disclosure, the scanning system 108 is a system used to collect and process the scan data for extracting the size of each features of the plurality of features. In addition, the scanning system 108 stores the database related to the size, image data, scan data and metadata for a plurality of users. In an embodiment of the present disclosure, the scanning system 108 shares a plurality of product features as a request to the automated apparel production system 204. In an example, the plurality of product features includes a set of product dimensions from body fitting, a closure type, a fabric type, a material type, a material elasticity, a material texture and a material weight of the apparel. The scanning system 108 shares the plurality of parameters of the user 202 required for the manufacturing of apparel. The plurality of parameters include size of each feature of the plurality of features, size chart of the body of the user 202 and the like. In an embodiment of the present disclosure, the automated apparel production system 204 receives the scan data of the user 202 from the scanning system 108.

In an embodiment of the present disclosure, the automated apparel production system 204 is a system used for the manufacturing of on demand apparel. The manufacturing of on demand apparel is based on the one or more parameters. The one or more parameters includes scan data of the user 202, preference of the user 202 related to the apparel, preference of the user 202 in size fitting, preference of the user 202 in material and color of fabric and the like. In addition, the one or more parameters include delivery date of apparel, placing of order of apparel, confirmation of order and the like.

In addition, the automated apparel production system 204 includes the plurality of manufacturing machines 206. In an example, the plurality of apparel manufacturing machines 206 includes but may not be limited to a cutting machine 206a, a stitching machine 206b and a finishing machine 206c. In addition, the plurality of apparel manufacturing machines 206 includes a printing machine, an embroidery machine, a coloring machine, a joining machine, a pattern drawing machine and a folding machine.

The cutting machine 206a is used to cut the fabrics or material of the apparel selected by the user 202 into one or more pieces to form a required pattern of the selected apparel. In an example, the cutting machine 206a includes a CNC Laser cutter to ease the cutting of fabrics. In addition, the stitching machine 206b is used to stitch the one or more pattern pieces cut by the cutting machine 206a to make the shape of the apparel selected by the user 202. Further, the finishing machine 206c is used to perform finishing work of the apparel. In an example, the finishing work includes removing unwanted pieces from the stitched apparel, ironing, washing, incorporating hardware and the like. Furthermore, the printing machine is used for performing printing operations on the fabrics or material selected by the user 202. The printing operations may include steps of applying specific designs, patterns, text and images on the material of the apparel selected by the user 202. Also, the embroidery machines are used for performing embroidery related work on the material of the apparel selected by the user 202. In an example, the embroidery related work is used for the decorative purpose. In another example, the embroidery related work includes designs on—quilts, wall hanging articles and pillows. The coloring machines are used to add colors on the material of the apparel selected by the user 202. In addition, the coloring machines are used to color the fibers, threads, fabrics and the like. In an example, the coloring is done to make the apparel attractive for the customers. The joining machines are used to join at least two different pieces of the apparel together. The folding machines are used for folding of the one or more apparel manufactured in a manufacturing unit. In an example, the folding machines are used to improve the appearance of the apparel. In addition, the folding machines reduce the cost of labor required for apparel folding related task.

In an embodiment of the present disclosure, the plurality of apparel manufacturing machines 206 is partially automated. In an example, the partially automated machines are operated automatically as well as required labor for the manufacturing of one or more apparel. In another embodiment of the present disclosure, the plurality of apparel manufacturing machines are fully automated and do not require any labor related work. In addition, the fully automated apparel manufacturing machines requires less time for the manufacturing of the one or more apparel. In an example, the fully automated apparel manufacturing machines are operated remotely.

The plurality of apparel manufacturing machines 206 is used for the mass production of the apparel in real time. In addition, the plurality of apparel manufacturing machines is used for the manufacture of apparel in a high quantity within a short interval of time to fulfill the demands of the customers. In an example, the plurality of apparel manufacturing machines 206 is used for the production of a large number of uniforms for the students associated with one or more schools. The production of large number of uniforms is done in a short period of time by using the plurality of apparel manufacturing machines. 206.

In an embodiment of the present disclosure, the apparel production system 204 receives a first set of data. The first set of data is associated with the body shape of the user 202. In addition, the first set of data is received from the scanning system 108. Further, the first set of data is received from the one or more scanners 104 associated with the scanning system 108. The one or more scanners 104 include 3D scanners, optical scanners, cameras, infrared scanners, laser scanners, robotic arms that can move to both sides of the user, rotating scanners and the like. The first set of data received from the one or more scanners 104 is used to extract sizing parameters of the body of the user 202. Furthermore, the first set of data includes a plurality of depth maps of the body of the user 202. Also, the first set of data characterizes a three-dimensional geometry of the body of the user 202 from a plurality of spatial parameters, a posture of the body, a position of each feature of a plurality of features of the body. In addition, the first set of data characterizes an axis of reference and a position of joints, two dimensional image of the body of the user, three dimensional image of the body of the user. Further, the first set of data characterizes scan data of the body of the user 202, size of each feature of the plurality of features and the like.

In an embodiment of the present disclosure, the first set of data is received from the one or more images uploaded by the user 202 on one or more sources. In addition, the one or more sources includes social profile of the user, web based platform and the like. Further, the first set of data received from the one or more images is used to estimate the body sized parameters of the user 202. Furthermore, the first set of data received from the one or more images is used to guess the choices of the user in color, fabrics, design, fit size and the like for the production and recommendation of apparel. Also, the machine learning algorithms are used to guess the choices of user from the real time data and the past data associated with the one or more sources from where the one or more images uploaded.

In an embodiment of the present disclosure, the automated apparel production system 204 allows the user 202 to select one or more apparel for which the user want on demand manufacturing. The user 202 may select the one or more apparel to be produced from the one or more available sources in real time. In an embodiment of the present disclosure, the one or more available sources include online sources. In another embodiment of the present disclosure, the one or more sources include offline sources. The online sources include the one or more web based platform to shop one or more apparel. For online sources, the user 202 must have a login id and a password. In addition, the user 202 must have all the details of his body and scan data on the profile. In an embodiment of the present disclosure, the user 202 having profile on the web based platform may select the one or more apparel in real time. In another embodiment of the present disclosure, the user 202 may customized the one or more apparel according to the need of the user 202. The offline sources for the user 202 include but may not be limited to a retail apparel shop having scanning system 108, any manufacturing plant of apparel having scanning system 108.

In an embodiment of the present disclosure, the automated apparel production system 204 collects the second set of data. In addition, the second set of data includes one or more preferences of the user 202. Further, the one or more preferences of the user 202 are asked by the automated apparel production system 204 for the production of selected apparel. Furthermore, the second set of data includes but may not be limited to one or more fit preferences, type of fabrics, type of notions, design preferences, brands preferences, and cost preferences. Also, the second set of data includes shape preference, color of fabric, choices of customized finishing, thread selection, choice of hardware and the like.

In an embodiment of the present disclosure, the one or more preferences of the user are recommended automatically by using machine learning algorithms and artificial intelligence techniques. In addition, the machine learning algorithms are based on past data and real time data of the user associated with the web based platform and social platform.

In an example, a user G uploads one or more images of him on social platform in different clothes. The automated apparel production system 204 fetches one or more information associated with the user 202 from the one or more images uploaded on the social platform. The one or more information may include information related to size, preference of the user in color, designs, type of clothes preferred by user and the like. The fetching of one or more information from the social platform is based on the machine learning algorithms.

In an example, the user X at place Y stands in front of the kiosk. In an embodiment of the present disclosure, the kiosk facilitates the scanning of the user X with the help of scanning system 108 installed in the kiosk. The kiosk asks for the user X preferences and allows the user X to select one or more apparel of the choice of the user X. Once the user X selects the apparel of choice, the kiosk shows the augmented image of user X in the selected apparel. The user X may also customize the selected apparel according to the choice or requirements. After finalization of the selected apparel, the user X places an order by choosing one or more mode of payments. After placing of order, the automated apparel production system 204 performs various operations for the manufacturing of selected apparel in real time.

In an embodiment of the present disclosure, the automated apparel production system 204 analyzes the first set of data and the second set of data. In addition, the analyzing of the first set of data and the second set of data is done to analyze the one or more information required for the production of the selected apparel. Further, the analyzing of the first set of data and the second set of data is done to check the unavailability of any required data for processing with manufacturing part. The analyzing of the first set of data and the second set of data is done in real time.

In an embodiment of the present disclosure, the automated apparel production system 204 starts manufacturing process for the apparel selected by the user 202. The automated apparel production system 204 switch to the manufacturing process after the confirmation of order by the user 202. The manufacturing process for the selected apparel starts with the cutting process. The cutting of the selected apparel is done by the cutting machine 206a based on the pattern of the selected apparel. In addition, the material of the selected apparel may be preferred by the user 202 for the cutting process. The cutting machine 206a cuts the material of the apparel into one or more apparel pieces based on the first set of data and the second set of data. Further, the cutting of the material preferred by the user 202 is done by one or more cutting tools to convert the material into the desired shape. In an example, the one or more cutting tools include blades, die cutters, laser cutters, automatic cutters and the like.

In an embodiment of the present disclosure, the cutting machine 206a starts cutting process when the user 202 confirm or place the order of the selected apparel. In an embodiment of the present disclosure, the cutting machine 206a is an automatic cutting machine. In another embodiment of the present disclosure, the cutting process may be manual. In yet another embodiment of the present disclosure, the cutting machine 206a may have one or more embedded chips configured with the one or more software algorithms for cutting the material automatically and efficiently. In an embodiment of the present disclosure, the one or more material being cut by the cutting machines 206a placed in a box having barcode or identity tag for further process. The barcoded box with the materials transfer to the next machine for further manufacturing process. The tag on the box represents the one or more information regarding placed order. In an example, the one or more information include sized parameters, delivery date and the like.

In an embodiment of the present disclosure, the plurality of apparel manufacturing machines 206 includes the stitching machine 206b. The stitching machine 206b stitches the one or more apparel pieces together to produce the apparel selected by the user 202. In addition, the stitching of the one or more apparel pieces is based on the first set of data and the second set of data. Further, the stitching machine 206b stitches the one or more pieces cut by the cutting machine 206a to form the shape of apparel as the shape of selected apparel. The stitching machine 206b stitches the one or more pieces of the material preferred by the user 202 to get the apparel similar to the selected one. In an embodiment of the present disclosure, the stitching machine 206b include lock stitching, chain stitching, rivet setter, bar tacker, pocket setter, pocket pattern stitching, button holer, belt loop machine, serger and the like. In another embodiment of the present disclosure, the stitching machine 206b include one or more sensors, one or more embedded chip configured with one or more software algorithm and the like. The one or more software algorithms facilitate the stitching machine 206b for automatic stitching of the one or more apparel pieces. In an embodiment of the present disclosure, the one or more stitching machines 206b is operated manually. In another embodiment of the present disclosure, the one or more stitching machines 206b facilitate automatic stitching of the one or more apparel.

In an embodiment of the present disclosure, the plurality of apparel manufacturing machines 206 includes a finishing machine 206c. The finishing machine 206c performs the one or more finishing operations on the stitched apparel. In an example, the one or more operations include but may not be limited to ironing, packaging, removing unwanted material, incorporating one or more hardware and the like. The one or more hardware includes rivets, buttons, snaps, hooks, hook-and-loop fasteners, elastic band, stitch styles and spacing, custom labels, zippers and embroidery and the like. In an embodiment of the present disclosure, the one or more hardware incorporating work is done manually. In another embodiment of the present disclosure, the one or more hardware incorporating work is done automatically by the plurality of apparel manufacturing machines 206. Further, the finishing work includes removing of unwanted threads from the apparel produced after stitching.

In addition, the finishing of the stitched apparel is done for the delivery purposes. The finalized apparel after passing through the plurality of apparel manufacturing machine 206 is packed and shipped to the one or more places. The one or more places includes address of the user 202, one or more retailer shops of apparel, places belong to the owner of apparel and the like.

In an embodiment of the present disclosure, each of the plurality of apparel manufacturing machines 206 performs one or more specific functions. In an embodiment of the present disclosure, the plurality of apparel manufacturing machines 206 includes machines required for the manufacturing of the apparel. In an example, each of the plurality of apparel manufacturing machines 206 includes one or more embedded chip configured with one or more software algorithm to perform manufacturing processes automatically. In another example, each of the plurality of apparel manufacturing machines 206 is operated manually. In yet another example, a fixed number of the machine of the plurality of apparel manufacturing machines 206 operated manually and another fixed number of machine of the plurality of apparel manufacturing machines 206 operated automatically.

In an embodiment of the present disclosure, the automated apparel production system 204 tracks the current status of the apparel produced by the plurality of apparel manufacturing machines 206. In addition, the tracking of the status of the production of apparel is done in real time with the help of one or more communication devices associated with the user 202. In an example, the user gets notification on the communication device about the current status of the apparel in a regular interval of time. Further, the user 202 may tracks the current location of the order in between the manufacturing place and the shipping place.

In an embodiment of the present disclosure, one or more entities are associated with the automated apparel production system 204. The one or more entities include organizations having uniform/workwear requirements. In an example, the organization includes school, Airlines, Manufacturing. In addition, the one or more entities include students, Manual workers, uniform/apparel users and the like. Further, the one or more entities include uniform suppliers, uniform manufactures, uniform sellers, retails fashion stores and the like.

The automated apparel production system 204 is associated with the server 210 through the communication network 208. In an embodiment of the present disclosure, the communication network 208 enables the automated apparel production system 204 to gain access to the internet. Moreover, the communication network 208 provides a medium for transfer of information between the automated apparel production system 204 and the server 210. Further, the medium for communication may be infrared, microwave, radio frequency (RF) and the like. The communication network 208 include but may not be limited to a local area network, a metropolitan area network, a wide area network, a virtual private network, a global area network, a home area network. The communication network 208 is a structure of various nodes or communication devices connected to each other through a network topology method. Examples of the network topology include a bus topology, a star topology, a mesh topology and the like. In addition, the server 210 handles each operation and task performed by the automated apparel production system 204. The server 210 stores one or more instructions for performing the various operations of the automated apparel production system 204. The server 210 is located remotely from any suitable place. In an embodiment of the present disclosure, the server 210 is associated with the administrator 212. The administrator 212 may be any person or individual. In an example, the administrator 212 may be a designer, a manufacturer, a distributor and a retailer.

In an example, the user X access a web based platform. The user X searches for the apparel on the web based platform. The web based platform asks for the login details and password from the user X. The user X is a registered user on the web based platform. The web based platform includes pre stored body scan data on the profile of the user X. The user X search for the apparel on the web based platform. The user X selects a white color full sleeve shirt from the multiple shirts available on the web based platform. In addition, the web based platform asks for the one or more user preferences for the white color shirt. The one or more user preferences include preferences for size, material of shirt, any customization in shirt related to pocket, button, collar and the like. After filling the preferences, the user X placed a request for the white shirt. The request placed by the user X passed for the approval of administrator on the web based platform. In an example, the approver may include manager, finance department, HR, decision makers of the organizations. The web based platform check whether the data provided by the user X is sufficient for the manufacturing process of shirt selected by the user X. Once the administrator of the web based platform satisfied with the data, the request placed by the user X get approved and the user X place order using one or more payment methods. The one or more payment methods include cash on delivery, online payment using debit card, credit card, net banking and the like. After confirmation of the order, the web based platform passed the order with various information regarding measurements, billing amount and delivery date to the one or more platforms associated with the manufacturing of the apparel. The one or more platforms include vendor location, apparel manufacture location and the like. The one or more platform starts manufacturing of the apparel selected by the user X and completes the work in a particular interval of time. In an example, the particular interval of time may be in minutes, hours or days depend on the type of apparel. After completing the manufacturing process of the order, the one or more platform provides shipping of the shirt to the receiver location within a specific time.

In an embodiment of the present disclosure, the automated apparel production system 204 is integrated into ERP of the one or more third parties for performing one or more operations. The one or more operations include monitoring status of production, doing payment transactions, tracking change in data related to the body measurements of the user and the like. In addition, the automated apparel production system 204 use employee ID card number from the ERP of the one or more third parties to track/store user information.

In an embodiment of the present disclosure, the automated apparel production system 204 facilitates in reducing wastage and Co2. The cutting of fabric is computer controlled which facilitates in the reducing wastage of fabrics. In addition, the automated apparel production system 204 places patterns on to a fabric through computer driven system. Thus, reduction in fabric wastage and fabric requirement also reduces Co2 footprints.

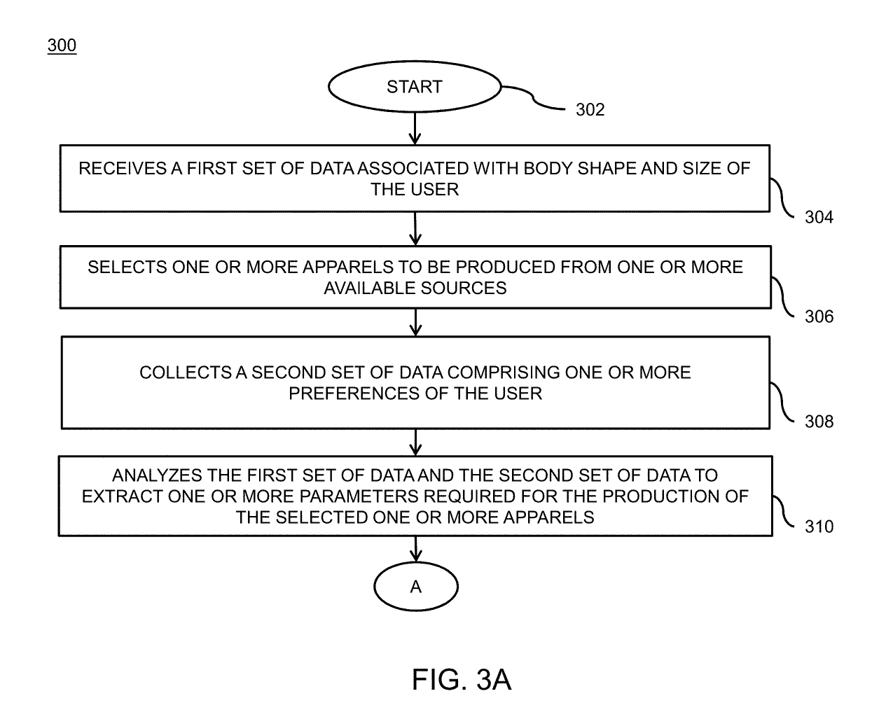

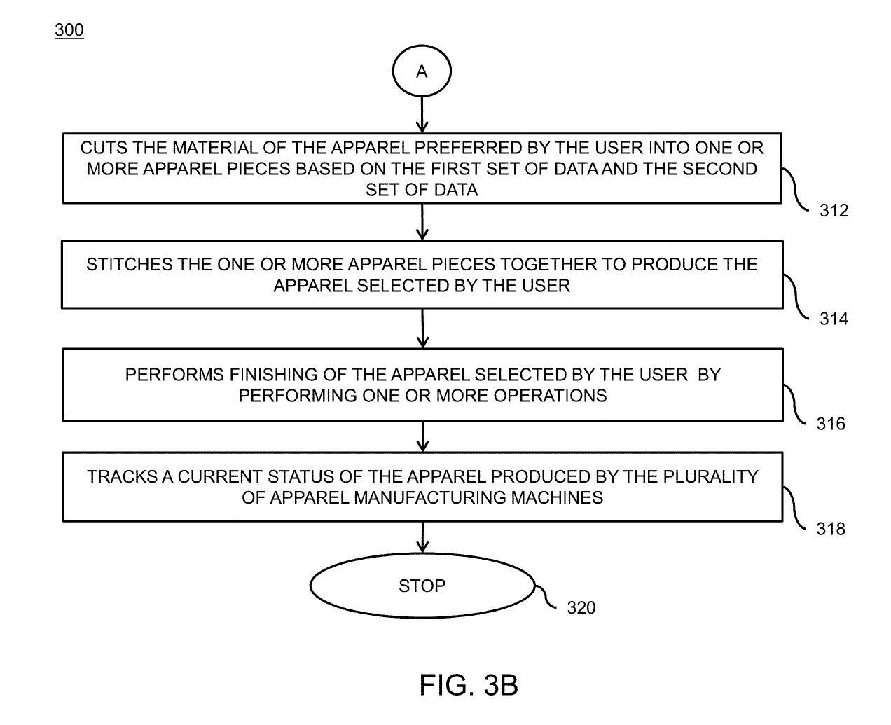

FIG. 3A and FIG. 3B illustrates a flowchart 300 for a method for rapid production of apparel based on processing of a plurality of depth maps of a body of a user, in accordance with various embodiments of the present disclosure. It may be noted that to explain the process steps of the flowchart 300, references will be made to the system elements of FIG. 2. It may be noted that the flowchart 300 may have lesser or more number of steps.

The flowchart 300 initiates at step 302. Following step 302, at step 304, the automated apparel production system 204 receives a first set of data associated with body shape and size of the user (102, 202). At step 306, the automated apparel production system 204 selects one or more apparel to be produced from one or more available sources. At step 308, the automated apparel production system 204 collects a second set of data comprising one or more preferences of the user. At step 310, the automated apparel production system 204 analyzes the first set of data and the second set of data to extract one or more parameters required for the production of the selected one or more apparel. At step 312, the automated apparel production system 204 cuts the material of the apparel preferred by the user (102, 202) into one or more apparel pieces based on the first set of data and the second set of data. At step 314, the automated apparel production system 204 stitches the one or more apparel pieces together to produce the apparel selected by the user (102, 202). At step 316, the automated apparel production system 204 performs finishing of the apparel selected by the user 102 by performing one or more operations. At step 318, the automated apparel production system 204 tracks a current status of the apparel being produced by the plurality of apparel manufacturing machines 206. The flow chart 300 terminates at step 320.

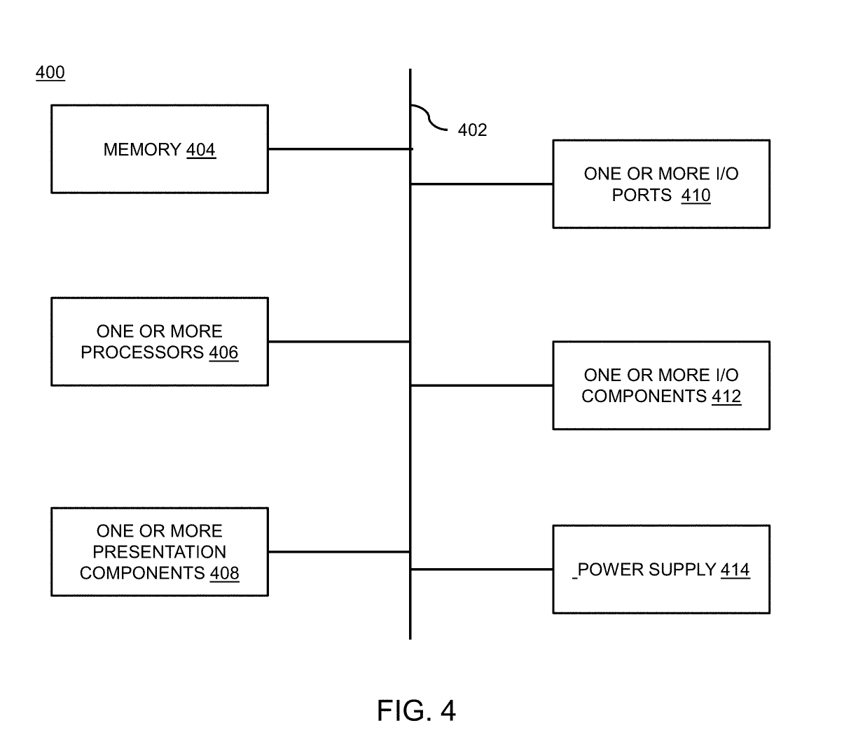

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from various entities such as memory 404 or I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The present disclosure has several advantages over the prior art. The present disclosure provides a solution for on demand production of the apparel to prevent excess collection of apparel in the store. In addition, the present disclosure provides solution for fast delivery of the on demand customized apparel. Further, the present disclosure provides a solution to display the image of the user overlaying selected apparel in a 3D virtual trial room and collect the body measurement related data automatically. Moreover, the present disclosure provides a solution to reduce the manpower requirement by replacing the manpower work with one or more automatic machines. The body of the user can be scanned even using a 3D scanner, a multi-camera device and a single camera device. The entire processing of the body scan data is performed remotely over the cloud. The user can place an order online for the customized apparel with the help of stored scan data. The user can even enter the preferred measurements into the system manually.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for a rapid production of apparel based on processing of a plurality of depth maps of a body of a user, the computer-implemented method comprising:
receiving, at an automated apparel production system with a processor, a first set of data associated with body shape and size of the user, wherein the first set of data is received from one or more scanners or one or more web based platforms to extract sizing parameters of the body of the user;
selecting, at the automated apparel production system with the processor, one or more apparel to be produced from one or more available sources, wherein the one or more available sources comprises online sources and offline sources and wherein the selection of the one or more apparel is done by the user in real time;
collecting, at the automated apparel production system with the processor, a second set of data comprising one or more preferences of the user, wherein the one or more preferences of the user is used for production of the selected apparel based on the preferences given by the user;
analyzing, at the automated apparel production system with the processor, the first set of data and the second set of data to extract one or more parameters required for the production of the selected one or more apparel, wherein the analyzing is done in real time;
cutting, at the automated apparel production system with the processor, material of the apparel preferred by the user into one or more apparel pieces based on the analyzing of the first set of data and the second set of data, wherein the cutting of the material preferred by the user is done by a plurality of apparel manufacturing machines;
stitching, at the automated apparel production system with the processor, the one or more apparel pieces together to produce the apparel selected by the user, wherein the stitching of the one or more apparel pieces is done based on the analyzing of the first set of data and the second set of data, wherein the stitching is done by the plurality of apparel manufacturing machines;
finishing, at the automated apparel production system with the processor, the apparel selected by the user by performing one or more operations, wherein the one or more operations comprises ironing, removing unwanted material, packaging and incorporating one or more hardware, wherein the finishing is done by the plurality of apparel manufacturing machines; and
tracking, at the automated apparel production system with the processor, a current status of the apparel produced by the plurality of apparel manufacturing machines, wherein the tracking of the current status of the apparel is done in real time.

2. The computer-implemented method as claimed in claim 1, wherein the first set of data comprises a plurality of depth maps of the body of the user, wherein the first set of data characterizes a three-dimensional geometry of the body of the user from a plurality of spatial parameters, a posture of the body, a position of each feature of a plurality of features of the body, an axis of reference and a position of joints, two dimensional image of the body of the user, three dimensional image of the body of the user, scan data of the body of the user and size of each feature of the plurality of features.

3. The computer-implemented method as claimed in claim 1, wherein the second set of data comprises one or more fit preferences, type of fabrics, type of notions, design preferences, brands preferences, monetary/cost preferences, shape preference, color of fabric, choice of customized finishing, thread selection and choice of hardware.

4. The computer-implemented method as claimed in claim 1, wherein the plurality of apparel manufacturing machines comprises cutting machines, printing machines, embroidery machines, coloring machines, stitching machines, joining machines, pattern drawing machines, folding machines and finishing machines, wherein the plurality of apparel manufacturing machines is used for the manufacturing of apparel in high quantity within in a short interval of time to fulfill demands of customers.

5. The computer-implemented method as claimed in claim 1, wherein the one or more preferences of the user is recommended automatically by using machine learning algorithms, wherein the machine learning algorithms is based on past data and real time data of the user associated with the one or more web based platform and social platforms.

6. The computer-implemented method as claimed in claim 1, wherein the plurality of apparel manufacturing machines is partially automated.

7. The computer-implemented method as claimed in claim 1, wherein the plurality of apparel manufacturing machines is fully automated.

8. The computer-implemented method as claimed in claim 1, wherein the first set of data is further received from one or more images uploaded by the user on one or more sources, wherein the one or more sources comprises social platforms and the web based platforms, wherein the first set of data received from the one or more images is used to estimate body size parameters, determine choices of the user in color, fabrics, design and fit sizes for the production and recommendation of apparel.

9. The computer-implemented method as claimed in claim 1, further comprising customizing, at the automated apparel production system with the processor, design of the apparel based on the second set of data, wherein the customization of apparel is done in real time.

10. A computer system comprising:
one or more processors; and
a memory coupled to the one or more processors, the memory for storing instructions which, when executed by the one or more processors, cause the one or more processors to perform a method for a rapid production of apparel based on processing of a plurality of depth maps of a body of a user, the method comprising:
receiving, at an automated apparel production system, a first set of data associated with body shape and size of the user, wherein the first set of data is received from one or more scanners or one or more web based platforms to extract sizing parameters of the body of the user;
selecting, at the automated apparel production system, one or more apparel to be produced from one or more available sources, wherein the one or more available sources comprises online sources and offline sources and wherein the selection of the one or more apparel is done by the user in real time;
collecting, at the automated apparel production system, a second set of data comprising one or more preferences of the user, wherein the one or more preferences of the user is used for production of the selected apparel based on the preferences given by the user;
analyzing, at the automated apparel production system, the first set of data and the second set of data to extract one or more parameters required for the production of the selected one or more apparel, wherein the analyzing is done in real time;
cutting, at the automated apparel production system, material of the apparel preferred by the user into one or more apparel pieces based on the analyzing of the first set of data and the second set of data, wherein the cutting of the material preferred by the user is done by a plurality of apparel manufacturing machines;
stitching, at the automated apparel production system, the one or more apparel pieces together to produce the apparel selected by the user, wherein the stitching of the one or more apparel pieces is done based on the analyzing of the first set of data and the second set of data, wherein the stitching is done by the plurality of apparel manufacturing machines;
finishing, at the automated apparel production system, the apparel selected by the user by performing one or more operations, wherein the one or more operations comprises ironing, removing unwanted material, packaging and incorporating one or more hardware, wherein the finishing is done by the plurality of apparel manufacturing machines; and
tracking, at the automated apparel production system, a current status of the apparel produced by the plurality of apparel manufacturing machines, wherein the tracking of the current status of the apparel is done in real time.

11. The computer system as recited in claim 10, wherein the first set of data comprises a plurality of depth maps of the body of the user, wherein the first set of data characterizes a three-dimensional geometry of the body of the user from a plurality of spatial parameters, a posture of the body, a position of each feature of a plurality of features of the body, an axis of reference and a position of joints, two dimensional image of the body of the user, three dimensional image of the body of the user, scan data of the body of the user and size of each feature of the plurality of features.

12. The computer system as recited in claim 10, wherein the second set of data comprises one or more fit preferences, type of fabrics, type of notions, design preferences, brands preferences, monetary/cost preferences, shape preference, color of fabric, choice of customized finishing, thread selection and choice of hardware.

13. The computer system as recited in claim 10, wherein the plurality of apparel manufacturing machines comprises cutting machines, printing machines, embroidery machines, coloring machines, stitching machines, joining machines, pattern drawing machines, folding machines and finishing machines and wherein the plurality of apparel manufacturing machines is used for the manufacturing of apparel in high quantity within in a short interval of time to fulfill demands of customers.

14. The computer system as recited in claim 10, wherein the one or more preferences of the user is recommended automatically by using machine learning algorithms, wherein the machine learning algorithms is based on past data and real time data of the user associated with the one or more web based platform and social platforms.

15. The computer system as recited in claim 10, wherein the plurality of apparel manufacturing machines is partially automated.

16. The computer system as recited in claim 10, wherein the plurality of apparel manufacturing machines is fully automated.

17. The computer system as recited in claim 10, wherein the first set of data is further received from one or more images uploaded by the user on one or more sources, wherein the one or more sources comprises social platforms and the web based platforms, wherein the first set of data received from the one or more images is used to estimate body size parameters, determine choices of the user in color, fabrics, design and fit sizes for the production and recommendation of apparel.

18. The computer system as recited in claim 10, further comprising customizing, at the automated apparel production system, design of the apparel based on the second set of data, wherein the customization of apparel is done in real time.

19. A computer-readable storage medium encoding computer executable instructions that, when executed by at least one processor, performs a method for a rapid production of apparel based on processing of a plurality of depth maps of a body of a user, the method comprising:
receiving, at a computing device, a first set of data associated with body shape and size of the user, wherein the first set of data is received from one or more scanners or one or more web based platforms to extract sizing parameters of the body of the user;
selecting, at the computing device, one or more apparel to be produced from one or more available sources, wherein the one or more available sources comprises online sources and offline sources and wherein the selection of the one or more apparel is done by the user in real time;
collecting, at the computing device, a second set of data comprising one or more preferences of the user, wherein the one or more preferences of the user is used for production of the selected apparel based on the preferences given by the user;
analyzing, at the a computing device, the first set of data and the second set of data to extract one or more parameters required for the production of the selected one or more apparel, wherein the analyzing is done in real time;
cutting, at the computing device, material of the apparel preferred by the user into one or more apparel pieces based on the analyzing of the first set of data and the second set of data, wherein the cutting of the material preferred by the user is done by a plurality of apparel manufacturing machines;
stitching, at the computing device, the one or more apparel pieces together to produce the apparel selected by the user, wherein the stitching of the one or more apparel pieces is done based on the analyzing of the first set of data and the second set of data, wherein the stitching is done by the plurality of apparel manufacturing machines;
finishing, at the computing device, the apparel selected by the user by performing one or more operations, wherein the one or more operations comprises ironing, removing unwanted material, packaging and incorporating one or more hardware, wherein the finishing is done by the plurality of apparel manufacturing machines; and
tracking, at the computing device, a current status of the apparel produced by the plurality of apparel manufacturing machines, wherein the tracking of the current status of the apparel is done in real time.
